(19) United States
(12) Patent Application Publication
(10) Pub. No.: US 2007/0016588 A1
(43) Pub. Date: Jan. 18, 2007

(54) Update system and related method

(75) Inventors: Chaucer Chiu, Taipei (TW); Strong Huang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/395,071

(22) Filed: Mar. 30, 2006

(30) Foreign Application Priority Data
Jul. 12, 2005 (TW) 94123492

(51) Int. Cl. G06F 17/30

(52) U.S. Cl. 707/10

(57) ABSTRACT

An update system and an update method are applicable to a computer terminal device conducting an online operation through a network construction and including a storage module, a temporary storage module and a central process module. The system includes a detection module and a load module. The method includes detecting whether a sub-program has been saved to the temporary storage module, loading an updated program to the temporary storage module if the sub-program has not been saved to the temporary storage module, otherwise, detecting whether the sub-program has been executed, detecting whether the sub-program is the updated program if the sub-program has not been executed, and loading the updated program to the temporary storage module if the sub-program is not the updated program. The update system and method prevent the online operation from being interrupted while conducting an update operation.

### FIELD OF THE INVENTION

The present invention relates to an online update technique, and, more particularly, to an update system and related method that conduct an update operation through a network construction without interrupting a server operation.

### Description of The Prior Art

With progress of the science and technology, many new things come into being and the online game is one of them. The online game enables a large number of players to play online at the same time, the players respectively and virtually playing as different roles in the online game. Therefore, the online game attracts more and more players and becomes the mainstream of the game.

Currently, most of the online games use a server/client mode. The game software is installed to the client terminals, such as PCs and PDAs, to obtain image and sound effects, and at the same time the client terminals are connected to a remote server through network communication devices such that the server could process information exchange between the terminals. Thereby players could smoothly play the online game.

However, the current update technique updates the main program and sub-programs of the server at the same time, which means that space occupied by the main program and sub-programs in the server is released at the same time. As a result, the online game process has to be closed and the server has to interrupt the game service until the server finishes updating.

In general, online game providers choose to interrupt service of the server late at night for an update operation. Although there are fewer players at this time, the update operation will result in interruption of the game process and bring inconvenience to those players who are enjoying the online game. Therefore, the service quality of the online game providers is deteriorated.

### SUMMARY OF THE INVENTION

According to the above drawbacks, the primary objective of the present invention is to provide an update system and related method which perform an update operation while the online game is being executed.

Another objective of the present invention is to provide an update system and related method which update data in a computer terminal device without interrupting the service of the server, thereby increasing service quality of the online game providers.

A further objective of the present invention is to provide an update system and method which enables game players to continue the game process while the server makes update operation.

To achieve the above and other objectives, the present invention provides an update system and related method, which update data of a computer terminal device during the online game process without interrupting service of the server. The update system of the present invention are able to be applied to a computer terminal device conducting an online game through a network construction. The computer terminal device at least includes a storage module for storing a main program and a sub-program needed by the online game, a temporary storage module for temporarily storing data to be immediately executed and a central process module for executing the online game. An updated programs corresponding to the sub-programs are pre-stored in the storage module. The update system of the present invention includes a detection module that is used to detect whether the sub-program needed for the online game has been saved to the temporary storage module, and further detect whether the sub-program is the updated program when the sub-program has been saved to the temporary storage module and has not been executed; and a load module that is used to load the updated program to the temporary storage module, the load module loading the updated program to the temporary storage module when the detection module has detected that the sub-program has not been saved to the temporary storage module or when the detection module has detected that the sub-program saved to the temporary storage module has not been executed and is not the updated program.

The update method of the present invention is executed by the update system. The update method includes detecting whether a sub-program has been saved in the temporary storage module of a computer terminal device, loading an updated program corresponding to the sub-program to the temporary storage module then, otherwise, further detecting whether the sub-program is being executed, further detecting whether the sub-program is an updated program if the sub-program has not been executed, and loading the updated program to the temporary storage module if the sub-program is not an updated program.

The update system and method of the present invention loads an updated program when the sub-program has not been loaded to the temporary storage module or when the sub-program in the temporary storage module has not been executed and is not the updated program. During the update operation, the main program as a scheduling center of the online game is not affected and the sub-program process for the online game needs not to be closed. Accordingly the game process could continue without the need of interruption.

Other aspects and features will become apparent to those ordinarily skilled in the art upon review of the following description of the preferred embodiments of the present invention in conjunction with the accompanying drawings.

### BRIEF DESCRIPTION OF THE DRAWINGS

FIG. 1 is a functional block diagram of a server comprising an update system according to the present invention.

FIG. 2 is a flow chart of an update method corresponding to the update system shown in FIG. 1.

### DESCRIPTION OF PREFERRED EMBODIMENTS

The update system and method of the present invention could be applied to a computer terminal device conducting an online operation through a network construction. The computer terminal device includes a storage module to store needed programs for the online operation, a temporary storage module to temporarily store needed programs to be executed immediately for the online operation, and a central process module to execute the online operation. In the present embodiment, the computer terminal device is a server and the online operation refers to an online game. It should be noted that the present invention is not limited thereto.

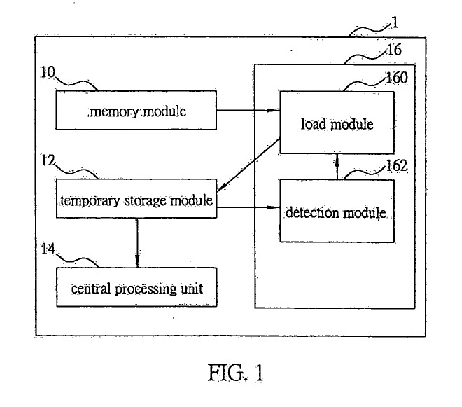

FIG. 1 is a functional block diagram of a server 1 comprising an update system 16 according to the present invention. It should be noted that FIG. 1 only shows compositions related to the present invention. The composition of the server 1 may be more complex.

As shown in FIG. 1, the server I comprises a storage module 10, a temporary storage module 12, a central process module 14 and the update system 16. The update system 16 comprises a load module 160 and a detection module 162.

The storage module 10 is used to store programs related with the online game, the programs including a main program and a plurality of sub-programs. In the present embodiment, the storage module 10 is a hard disk.

The temporary storage module 12 is used to temporarily store programs needed for the online game to be executed immediately in order to speed up program execution. In the present embodiment, the temporary storage module 12 is a memory component of the server 1.

The central process module 14 is used to execute the online game and the programs stored in the temporary storage module 12 that need to be executed immediately for the online game. The central process module 14 acts a control and process center of the server 1. In the present embodiment, the central process module 14 is a central processing unit (CPU) of the server 1.

In the present embodiment, the main program refers to a service program for the online game and the sub-programs refer to events of the online game. A plurality of the sub-programs are used to achieve different effects. The online game runs in the server 1 and the service program is stored in the temporary storage module 12 of the server 1. When a game player requires an event to be executed during playing the online game, the service program will call the sub-program related to the event, which will further be executed by the central process module 14.

An updated program is pre-stored in the storage module 10 mounted to the server 1. The updated program is an executable file, script of which has been compiled. In the present embodiment, the executable file and other programs related to the online game are saved in one single directory such that the load module 160 could quickly load the updated program of the storage module 10 to the temporary storage module 12. It should be noted that the updated program corresponding to the sub-program could also be saved in other different directories.

The update system 16 is used to update the sub-programs of the online game such that players could access the newest game contents. When a game player requires a sub-program (an event) to be executed during playing, the detection module 160 detects whether the sub-program has been saved in the temporary storage module 12. If the sub-program has not been saved in the temporary storage module 12, the load module 160 will load the updated program to the temporary storage module 12, otherwise, the detection module 160 will detect whether the sub-program is being executed by other game players. If the sub-program is being executed, the central process module 14 will continue execution; otherwise, the detection module 160 further detects whether the sub-program is an updated program. If the sub-program is not the updated program, the detection result will be sent to the central process module 14 which will further drive the temporary storage module 12 to release space occupied by the sub-program and load the updated program.

Moreover, in order to easily identify whether a sub-program is an updated program, marks such as time marks could be disposed on the updated program and the executable file.

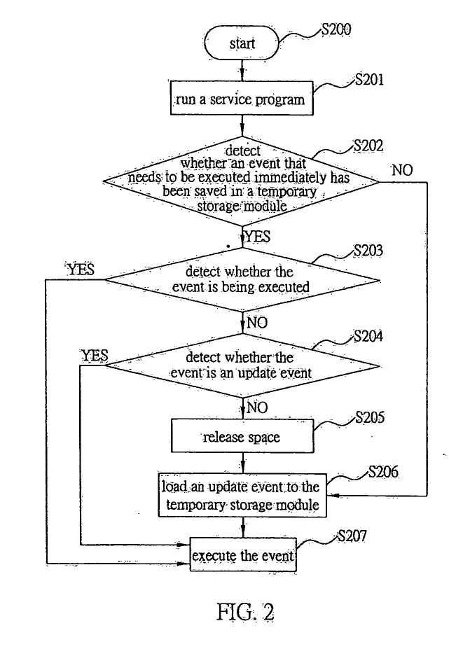

FIG. 2 is a flow chart of an update method corresponding to the update system 16 according to the present invention. In the following description, a term “event” is used to replace a term “sub-program” in accordance with the present embodiment.

As shown in FIG. 2, the update method starts in step S200, then proceeds to step S201.

In step S201, the central process module 14 runs the service program needed by the online game. Then proceeds to step S202.

In step S202, the detection module 162 detects whether the event that needs to be executed immediately has been saved in the temporary storage module 12. If so, proceed to step S203, otherwise, proceed to step S206.

In step S203, the detection module 162 detects whether the event is being executed. If so, proceed to step S207, otherwise, proceed to step S204.

In step S204, the detection module 162 detects whether the event is an update event. If so, proceed to step S207, otherwise, proceed to step S205.

In step S205, the update system 16 sends the detection result to the central process module 14, which further drives the temporary storage module 12 to release space occupied by the sub-program. Then proceed to step S206.

In step S206, the load module 160 loads the update event to the temporary storage module 12. Then proceed to step S207.

In step S207, the central process module 14 executes the event as a succession of step S204 or step S206.

According to the update system 16 of the present invention, an online game server is allowed to directly update events while executing the service program. That is, when an event, i.e. a sub-program, required by a game player has not been saved to the temporary storage module 12 or when the event in the temporary storage module 12 has not been executed by other game players, the update event could be directly loaded to the temporary storage module 12. Compared with the prior art wherein the server has to interrupt the service and accordingly interrupt the game process of the players, the present invention enables the game players to access the newest game contents without interrupting the online game process, thereby enhancing service quality of the online game providers.

Although the present invention has been described in accordance with the embodiments shown, it would be appreciated by those skilled in the art that changes may be made without departing from the sprit and principles of the present invention.

What is claimed is:

1. An update system for a computer terminal device conducting an online operation through a network construction and having a storage module, a temporary storage module and a central process module, the update system comprising:
a detection module for detecting whether a sub-program needed for the online operation has been saved to the temporary storage module, and further detecting whether the sub-program is an updated program when the detection module has detected that the sub-program has been saved to the temporary storage module and has not been executed; and
a load module for loading the updated program to the temporary storage module when the detection module has detected that the sub-program has not been saved to the temporary storage or when the detection module has detected that the sub-program in the temporary storage module has not been executed and is not the updated program.

2. The update system of claim 1, wherein the online operation refers to an online game.

3. The update system of claim 1, wherein the updated program is an executable file, script of which has been compiled.

4. The update system of claim 1, wherein the updated program is saved in a single directory.

5. The update system of claim 1, wherein the computer terminal device is a server.

6. An update method for a computer terminal device conducting an online operation through a network construction and having a storage module, a temporary storage module and a central process module conducted by an update system, the update method comprising the steps of:
detecting whether a sub-program needed for the online operation has been saved in the temporary storage module;
loading an updated program corresponding to the sub-program to the temporary storage module upon detecting that the sub-program has not been saved to the temporary storage module, otherwise, detecting whether the sub-program executed and further detecting whether the sub-program is the updated program upon detecting that the sub-program has not been executed; and
loading the updated program to the temporary storage module upon detecting that the sub-program is not the updated program.

7. The update method of claim 6, wherein the update system comprises a detection module and a load module.

8. The update method of claim 6, wherein the online operation refers to an online game.

9. The update method of claim 6, wherein the updated program is an executable file, script of which has been compiled.

10. The update method of claim 6, wherein the updated program is saved in a single directory.

11. The update method of claim 6, wherein the computer terminal device is a server.
